(19) United States
(12) Patent Application Publication
(10) Pub. No.: US 2026/0186953 A1
(43) Pub. Date: Jul. 2, 2026

(54) AUTOMATED TESTING OF WEB PAGE LAYOUTS

(71) Applicant: International Business Machines Corporation, Armonk, NY (US)

(72) Inventors: Chan Gao, Beijing (CN); Der-Joung Wang, New Taipei City (TW); Bai Xin Jiang, Beijing (CN); Min Kang Zhang, Beijing (CN); Xiao Lei Jia, Beijing (CN)

(21) Appl. No.: 19/008,452

(22) Filed: Jan. 2, 2025

(51) Int. Cl. G06F 11/3668

(52) U.S. Cl. CPC G06F 11/3672

(57) ABSTRACT

A method, according to one approach, is for: receiving a screenshot of a graphical user interface on a base device output in response to the base device accessing a web page. The screenshot is used to identify elements in the graphical user interface. Moreover, outer borders of the respective identified elements are marked. An original distribution of the identified elements is determined, and an original area inside the outer borders is also determined. The method further includes determining original margin sizes between edges of the graphical user interface and the outer border of adjacent ones of the identified elements.

### BACKGROUND

The present invention relates to web pages, and more specifically, this invention relates to web page layout verification.

Network connectivity has been introduced to a variety of different devices in an attempt to meet increasing demand. While different network compatible devices may be capable of accessing the same information (e.g., over a network), the information itself may be utilized differently. For example, different types of network compatible devices have different configurations and accesses web pages over network connections differently.

Thus, while a web page may be designed for access on a mobile phone connected to a network, it may also be accessed by personal computers, mainframe computers, etc., that are connected to the network, each of which may have significantly different accessibility demands. Certain network devices may thereby effectively be prevented from reliably accessing information presented on web pages.

### SUMMARY

A method, according to one approach, includes: receiving a screenshot of a graphical user interface (GUI) on a base device output in response to the base device accessing a web page. The screenshot is used to identify elements in the GUI. Moreover, outer borders of the respective identified elements are marked. An original distribution of the identified elements is determined, and an original area inside the outer borders is also determined. The method further includes determining original margin sizes between edges of the GUI and the outer border of adjacent ones of the identified elements.

A computer program product, according to another approach, includes: one or more computer-readable storage media. The computer program product also includes program instructions that are stored on the one or more storage media to perform the foregoing method.

A computer system, according to yet another approach, includes: a processor set, and one or more computer-readable storage media. The computer system also includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a representational view of components in the distributed system of FIG. 2A, in accordance with one approach.

FIG. 3A is a flowchart of a method, in accordance with one approach.

FIG. 3B is a flowchart of sub-processes for one or more of the operations in the method of FIG. 3A, in accordance with one approach.

FIG. 3C is a flowchart of sub-processes for one of the operations in the method of FIG. 3A, in accordance with one approach.

FIGS. 4A-4D are the steps of a progression, in accordance with an in-use example.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for automatically testing the layout of a GUI in a number of different configurations. Approaches herein may thereby determine whether the layout of a GUI changes by a sufficient amount on different devices. As noted above, different network compatible devices have different configurations (e.g., display sizes, aspect ratios, programming languages, etc.) which impacts if and/or how a GUI is able to present certain details. Approaches are thereby able to improve the accessibility of information across network compatible devices by automatically testing how the layout of interactive sources of information are impacted in a variety of different configurations. This is particularly true with respect to responsive web pages having flexible characteristics that are generally designed to adapt to different network compatible devices., e.g., as will be described in further detail below.

In one general approach, a method includes: receiving a screenshot of a GUI on a base device output in response to the base device accessing a web page. The screenshot is used to identify elements in the GUI. Moreover, outer borders of the respective identified elements are marked. An original distribution of the identified elements is determined, and an original area inside the outer borders is also determined. The method further includes determining original margin sizes between edges of the GUI and the outer border of adjacent ones of the identified elements.

In another general approach, a computer program product includes: one or more computer-readable storage media. The computer program product also includes program instructions that are stored on the one or more storage media to perform the foregoing method.

In yet another general approach, a computer system includes: a processor set, and one or more computer-readable storage media. The computer system also includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved layout verification code at block 150 for automatically testing the layout of a GUI in a number of different configurations. Approaches herein may thereby determine whether the layout of a GUI changes by a sufficient amount on different devices. As noted above, different network compatible devices have different configurations (e.g., display sizes, aspect ratios, programming languages, etc.) which impacts if and/or how a GUI is able to present certain details. Approaches are thereby able to improve the accessibility of information across network compatible devices by automatically testing how the layout of interactive sources of information are impacted in a variety of different configurations. This is particularly true with respect to responsive web pages having flexible characteristics that are generally designed to adapt to different network compatible devices., e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

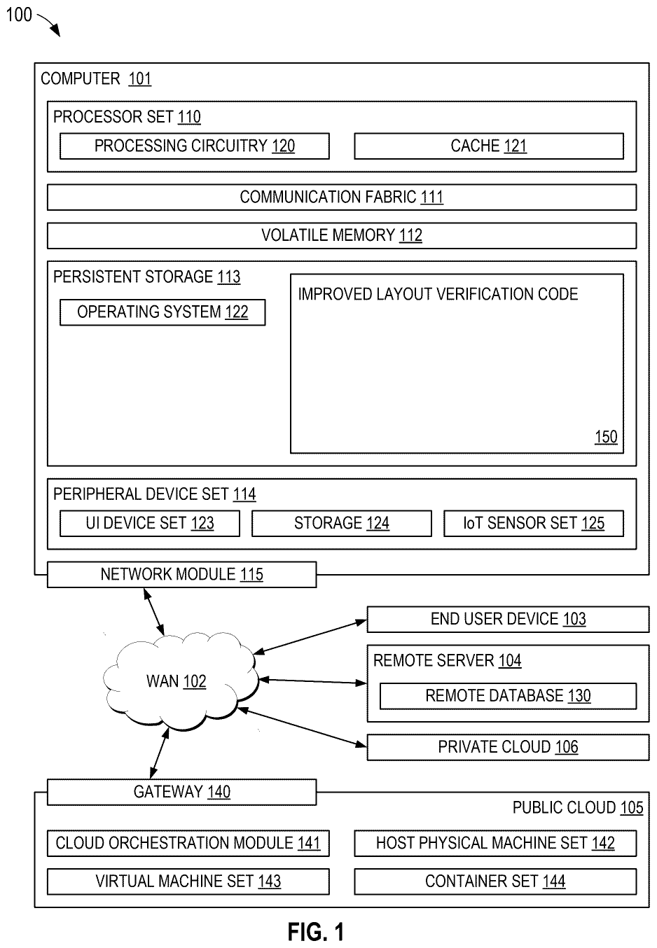

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As mentioned above, network connectivity has been introduced to a variety of different devices in an attempt to meet increasing demand. While different network compatible devices may be capable of accessing the same information (e.g., over a network), the information itself may be utilized differently. For example, different types of network compatible devices have different configurations and accesses web pages over network connections differently. Thus, while a web page may be designed for access on a mobile phone connected to a network, it may also be accessed by personal computers, mainframe computers, etc., that are connected to the network, each of which may have significantly different accessibility demands. Certain network devices may thereby effectively be prevented from reliably accessing information presented on rigid web pages.

In contrast to these conventional shortcomings, approaches herein preferably utilize responsive web pages to improve the accessibility of information across a variety of situations. Responsive web pages have flexible characteristics and are generally designed to adapt to the network compatible device that is actually accessing the responsive web pages. In other words, responsive web pages are ideally flexible websites having content and designs that behave like water, filling whatever container they are placed into (e.g., loaded on). A responsive website may thereby be implemented successfully regardless of a screen size, orientation, operating platform, etc., that are present in the given network compatible device accessing the responsive web page.

While responsive web pages are preferably configured such that they are able to adapt to a number of different access scenarios, approaches herein are able to achieve this without significantly increasing latency. For example, rather than manually performing tedious and repetitive layout verifications for each type of network compatible device, viewport size, resolution, etc. that may potentially be used to access a responsive web page, approaches herein are desirably able to achieve web development that uses flexible grids, responsive images, and media queries to achieve compatibility with a variety of network compatible components.

Each component of a responsive web page may thereby undergo change(s) to be included inside the outer boundaries of a screen displaying a GUI on a network compatible device. For example, the components may shrink to fit into smaller device screens or, on the contrary, stretch to occupy devices having larger screen surface areas. This may be accomplished in some approaches by resizing viewports, modifying displayed resolutions, shifting between layout configurations, etc. Moreover, this scaling is preferably done automatically to match the respective network compatible device.

This allows approaches herein to verify web page layouts work properly in a variety of different environments without manually testing each of them. The automated approaches described herein may thereby be able to efficiently identify layout issues in responsive web pages and/or other types of adaptive applications, and ensure they are resolved such that any network compatible device is able to properly access information on the web pages, e.g. as will be described in further detail below.

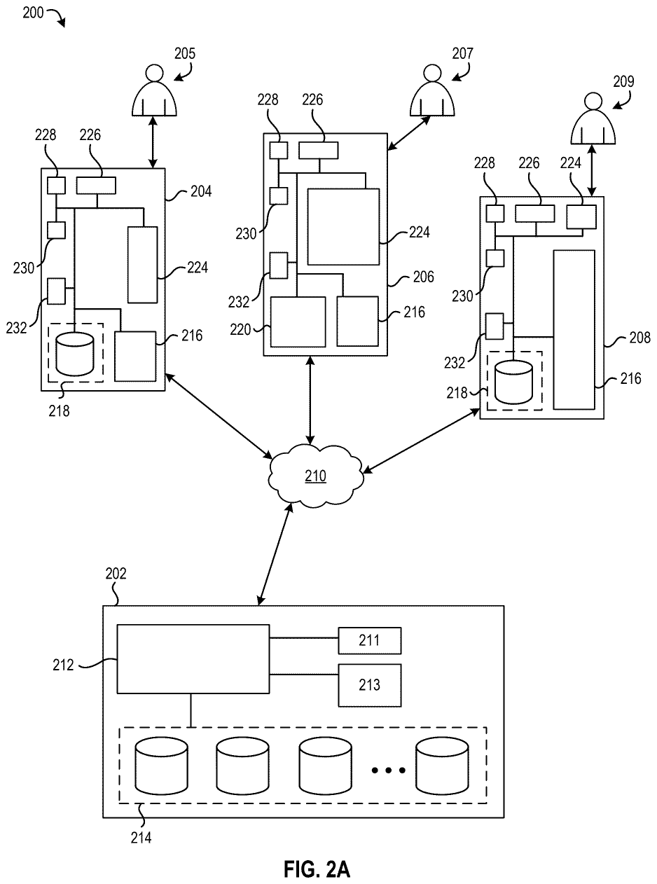

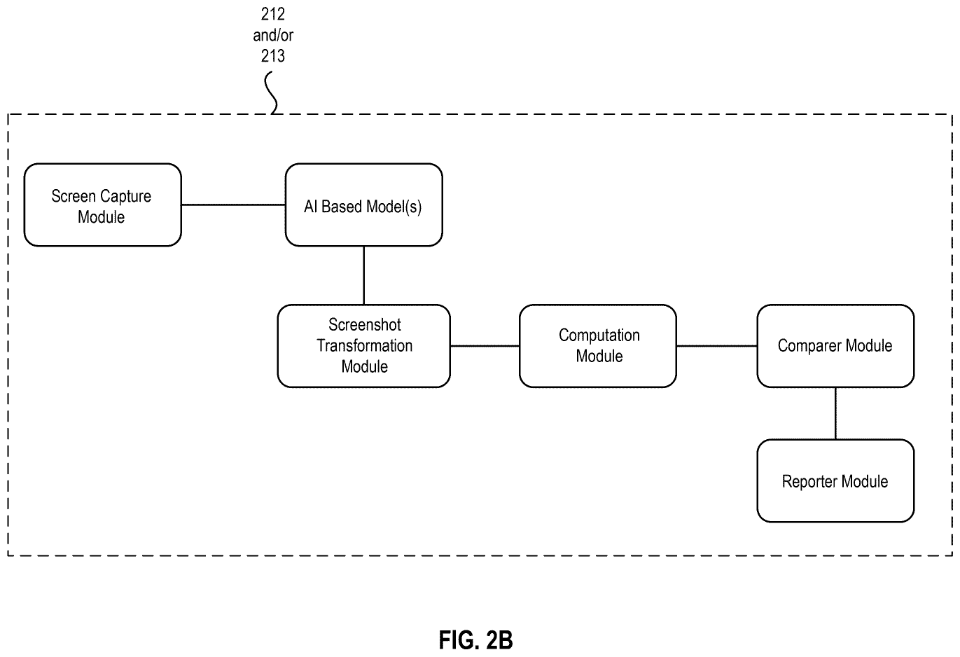

Looking now to FIG. 2A, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2A (and the other FIGS.) may be deemed to include any possible permutation.

As shown, the system 200 includes a central server 202 that is connected to electronic devices 204, 206, 208 accessible to the respective users 205, 207, 209. Each of these electronic devices 204, 206, 208, the users 205, 207, 209 may be separated from each other such that they are positioned in different geographical locations. For instance, the central server 202 and electronic devices 204, 206, 208 are connected to a network 210.

The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between users 205, 207, 209 using the electronic devices 204, 206, 208 and/or central server 202, regardless of the amount of separation which exists therebetween, e.g., despite being positioned at different geographical locations.

However, it should also be noted that two or more of the electronic devices 204, 206, 208 and/or central server 202 may be connected differently depending on the approach. According to an example, which is in no way intended to limit the invention, two edge compute nodes may be located relatively close to each other and connected by a wired connection, e.g., a cable, a fiber-optic link, a wire, etc.; etc., or any other type of connection which would be apparent to one skilled in the art after reading the present description.

While the electronic devices 204, 206, 208 are depicted as having some similarities, this is in no way intended to be limiting. For instance, the electronic devices 204, 206, 208, each are shown as including a processor 216 coupled to memory 218, 220. The memory implemented at each of the electronic devices 204, 206, 208 may be used to store data received from one or more sensors (not shown) in communication with the respective electronic devices, the users 205, 207, 209 themselves, the central server 202, different systems also connected to network 210, etc. It follows that different types of memory may be used. According to an example, which is in no way intended to limit the invention, electronic devices 204 and 208 may include hard disk drives as memory 218 while electronic device 206 includes a solid state memory module as memory 220.

The processor 216 is also shown as being connected to a display screen 224, a keyboard 226, a computer mouse 228, a microphone 230, and a camera 232. The processor 216 may thereby be configured to receive inputs from the keyboard 226 and computer mouse 228 as entered by the users 205, 207, 209. These inputs typically correspond to information presented on the display screen 224 while the entries were received. Moreover, the inputs received from the keyboard 226 and computer mouse 228 may impact the information shown on display screen 224, data stored in memory 218, 220, information collected from the microphone 230 and/or camera 232, status of an operating system being implemented by processor 216, etc.

While some aspects of the electronic devices 204, 206, 208 are similar, the devices also include unique features. In one example, each of the electronic devices 204, 206, 208 include display screens 224 of different sizes. Information may thereby be depicted on the display screens 224 using different aspect ratios, text and/or image sizing, etc. For instance, GUIs presented on the display screens 224 may be adjusted based at least in part on the sizes of the respective screens and what information is being presented thereon. In other approaches, the electronic devices 204, 206, 208 may have processors of different sizes capable of achieving different levels of compute throughput. In still other approaches, the electronic devices 204, 206, 208 may implement (e.g., run) different operating software impacting how information is accessed from a publicly available web page.

It follows that each of the electronic devices 204, 206, 208 may access (e.g., load) and/or display the information that is available in response to visiting a web page (e.g., a responsive web page) differently. Again, the layout of a GUI may differ significantly depending on a configuration of the device that the information is loaded onto for display. Automatically testing the layout of a GUI in a number of different configurations and determining whether the layout changes a sufficient amount between the different configurations as described herein thereby improves the accessibility of information across network compatible devices. This is particularly true with respect to responsive web pages having flexible characteristics that are generally designed to adapt to network compatible devices, e.g., as will be described in further detail below.

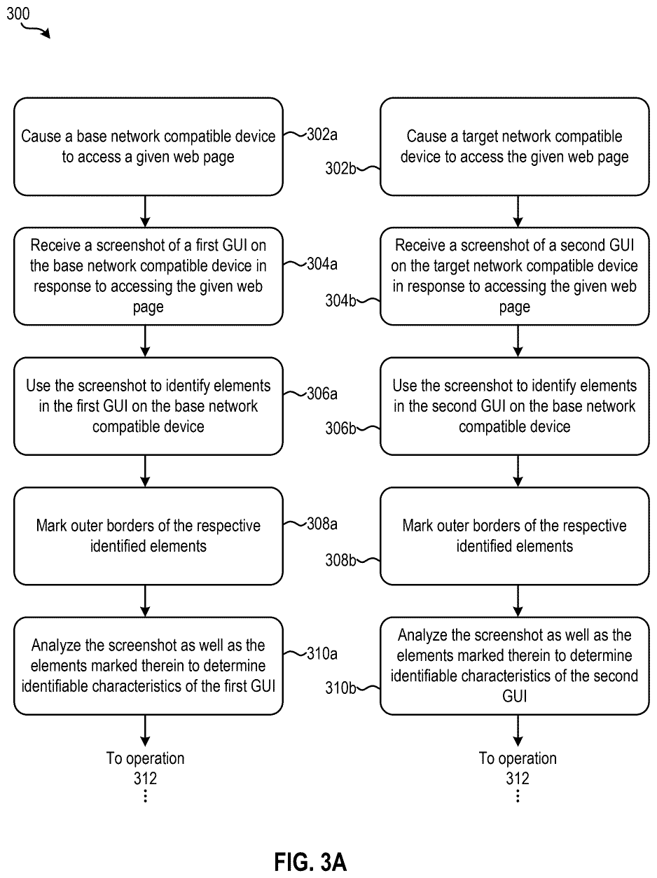

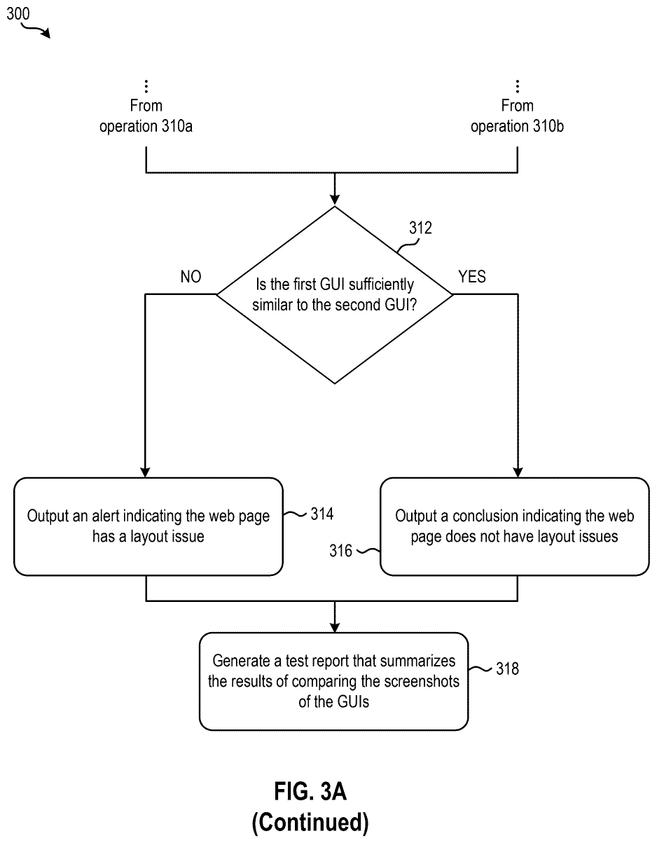

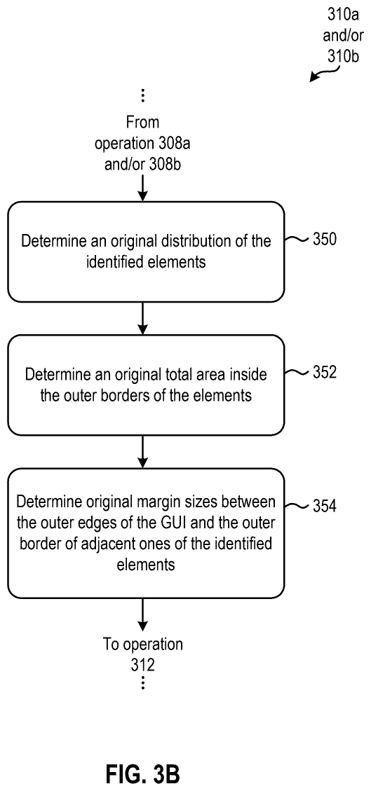

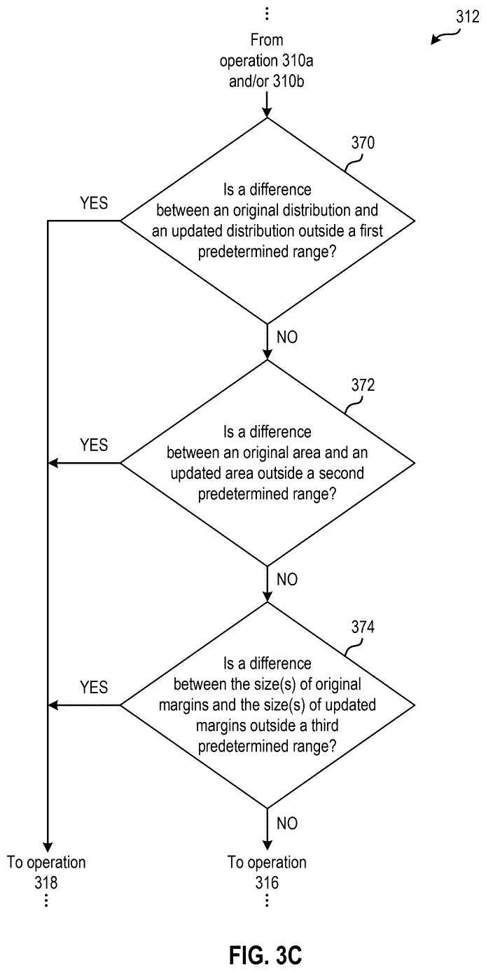

With continued reference to FIG. 2A, it should also be noted that the display screen 224, the keyboard 226, the computer mouse 228, microphone 230, and camera 232 are each coupled directly to the processor 216 in the present implementation. Accordingly, inputs received from the keyboard 226 and/or computer mouse 228 may be evaluated before being implemented in the operating system and/or shown on display screen 224. For example, processors 216 in the electronic devices 204, 206, 208 may perform any one or more of the operations described below in method 300 of FIG. 3A in order to improve access to information presented on a web page or other accessible location.

While the electronic devices 204, 206, 208 are depicted as including similar components and/or design, it should again be noted that each of these electronic devices 204, 206, 208 may include any desired components which may be implemented in any desired configuration. In some instances, each user device (e.g., mobile phone, laptop computer, desktop computer, etc.) connected to a network may be configured differently to provide each location with a different functionality. According to an example, which is in no way intended to limit the invention, electronic devices 204 may include a cryptographic module (not shown) that allows the user 205 to produce encrypted data, while electronic devices 206 includes a data compression module (not shown) that allows for data to be compressed before being sent over the network 210 and/or stored in memory, thereby improving performance of the system by reducing network strain and/or compute overhead at the electronic device itself. It follows that the different electronic devices (e.g., user devices) in system 200 may have different performance capabilities.

The electronic devices 204, 206, 208 also have a different configuration than the central server 202. For example, in some implementations the central server 202 includes a large (e.g., robust) processor 212 coupled to a cache 211, an AI module 213, and a data storage array 214 having a relatively high storage capacity. The central server 202 is thereby able to process and store a relatively large amount of data, as well as evaluate and process screen sharing video streams received from a presenter and intended for one or more participants of a group video call. This allows the central server 202 to connect to, and manage, the exchange of information with different network accessible devices. For instance, this may be achieved at least in part by receiving access requests from different types of mobile devices, and configuring access points for the respective mobile devices.

The AI module 213 may include any desired number and/or type of AI based models, e.g., such as machine learning models, deep learning models, neural networks, etc. In preferred approaches, the AI module 213 may include one or more AI based models that have been trained to evaluate the information that is presented in a GUI on different devices. For instance, approaches herein build and train one or more AI based models such that they are configured to compare different details present in a GUI and how those details are impacted based on the physical device the GUI is loaded in. As noted above, this desirably allows approaches herein to automatically test the layout of a GUI in a number of different devices having different configurations, and determining whether the layout changes a sufficient amount between the different configurations. This improves the accessibility of information across network compatible devices, particularly with respect to responsive web pages having flexible characteristics that are generally designed to adapt to different network compatible devices. For example, some approaches involve using a trained visual-based AI model (e.g., having optical character recognition capabilities and/or machine learning) to scan (inspect) a GUI and recognize elements therein, e.g., as will be described in further detail below.

Looking momentarily to FIG. 2B, a representational view of the components that may be included in the processor 212 and/or AI module 213 in order to evaluate information that is presented in GUIs on different devices. Accordingly, one or more of the modules depicted in FIG. 2B may be used to perform at least some of the operations below in method 300.

As shown, a Screen Capture Module is connected to a module having a desired number of AI Based Models. The Screen Capture Module may be configured to capture snapshots of GUIs as they are presented. In other words, the Screen Capture Module is preferably able to capture a visual representation of the details (e.g., elements) that are presented to a user in a GUI in response to accessing a given web page. Moreover, the AI Based Model(s) are used to evaluate screenshots received from the Screen Capture Module. The AI Based Model(s) have preferably been trained such that they are configured to identify elements of interest in the GUI snapshots that are received. For example, the AI Based Model(s) may include visual based (e.g., OCR) machine learning models that can identify text, images, animations, etc. in a GUI screenshot. The AI Based Model(s) may further be configured to add outer boarders around each of the identified elements, e.g., as will be described in further detail below.

FIG. 2B also includes a Screenshot Transformation Module that is preferably able to make modifications to the GUI screenshot. For example, the Screenshot Transformation Module may modify an aspect ratio, placement, sizing, etc., of the elements identified in the screenshot. These modifications may correspond to (e.g., imitate) changes being made to the device(s) that access the web page and/or the web page itself. For example, changes may be made in an attempt to make the GUIs on different devices more uniform.

The Computation Module may further be used to determine various characteristics of the GUI screenshots. For instance, the Computation Module may be used to determine a distribution of the identified elements across the screenshot of a GUI. In some approaches, the Computation Module is used to determine a total area inside the outer borders of the elements. In still other approaches, the Computation Module is used to determine margin sizes between outer edges of the GUI and the outer borders the identified elements.

Furthermore, the Comparer Module may be used to compare the screenshot characteristics determined by the Computation Module. For instance, the Comparer Module may compare a distribution and/or an area of the elements in different GUI screenshots. The Comparer Module may also compare margin sizes in different GUI screenshots. According to one example, the Comparer Module may evaluate the elements using one or more computer vision libraries (e.g. OPENCV). Furthermore, Reporter Module may be configured to output an alert that indicates whether two or more GUI screenshots are sufficiently similar to each other. For example, the Reporter Module may send an alert indicating whether a given web page has a layout issue. Depending on the approach, the alert may be sent (e.g., transmitted) to an administrator (e.g., architect) of the web page, a manufacturer of the network compatible device used to access the web page, a user attempting to access the web page, etc. The alert may thereby desirably cause the web page and/or the GUIs of network compatible devices used to access the web page are modified such that consistency across the GUIs of the devices are consistent.

Referring back now to FIG. 2A, the central server 202 may also store at least some information collected from the remote locations. For instance, central server 202 may include details about each of the different electronic devices 204, 206, 208; web pages accessed by the electronic devices 204, 206, 208; GUIs displayed by the electronic devices 204, 206, 208; preferences of the users 205, 207, 209; etc. For instance, user defined authentication information (e.g., passwords), activity-based information (e.g., geographic location), application preferences, performance metrics, public and/or private web page addresses, etc., may be collected from the users 205, 207, 209 leading up to, and during, accessing information available at a given location (e.g., web page). Additionally, at least some of the information that is collected may be hashed and randomized before being stored in memory in some approaches. For instance, some approaches include encrypting and storing preferential selections, geographical location information, passwords, etc. This information can later be used to customize at least certain details that are displayed on a GUI of a network compatible device.

Looking now to FIG. 3A, a method 300 for automatically testing the layout of a GUI in a number of different configurations, is shown according to one approach. One or more of the operations in method 300 may thereby be performed to determine whether the layout of a GUI changes by a sufficient amount in response to being implemented (e.g., loaded) on different devices. As noted above, different network compatible devices have different configurations (e.g., display sizes, aspect ratios, programming languages, etc.) which impacts if and/or how a GUI is able to present certain details to a user. Operations in method 300 are thereby able to improve the accessibility of information across network compatible devices by automatically testing how the layout of interactive sources of information are impacted in a variety of different configurations. This is particularly true with respect to responsive web pages having flexible characteristics that are generally designed to adapt to different network compatible devices.

In some approaches, one or more of the operations in method 300 may be performed by AI based models that have undergone training to evaluate the information that is presented in a GUI on different devices. For instance, approaches herein build and train one or more AI based models such that they are configured to compare different details present in a GUI and how those details are impacted based on the physical device the GUI is loaded in and/or logical components therein. Accordingly, the operations of method 300 may be performed continually in the background of an operating system without requesting input from a participant (e.g., human). Moreover, while certain results (e.g., warnings, reports, suggestions, etc.) may be generated and/or issued regarding a source of information (e.g., a responsive web page), it is again noted that the various operations of method 300 can be repeated in an iterative fashion to vet any desired number of network compatible devices. Thus, method 300 may be performed in accordance with the present invention in any of the environments depicted in FIGS. 1-2, among others, in various approaches. Of course, more or less operations than those specifically described in FIG. 3A may be included in method 300, as would be understood by one of skill in the art upon reading the present descriptions.

Each of the steps of the method 300 may be performed by any suitable component of the operating environment. For example, in some approaches one or more of the operations in method 300 may be performed by a source hardened AI based model which is implemented in an AI based module (e.g., see AI module 213 of FIG. 2A). However, the method 300 may be partially or entirely performed by a controller, a processor, a computer, etc., or some other device having one or more processors therein. Moreover, the terms computer, processor and controller may be used interchangeably with regards to any of the embodiments herein, such components being considered equivalents in the many various permutations of the present invention.

For those embodiments having a processor, the processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown, operation 302a includes causing a base network compatible device to access a given web page. In other words, operation 302a includes sending one or more instructions that result in (e.g., cause) a base device sending an access request to a predetermined web page. The access request may thereby be satisfied, allowing for information to be returned from the web page to the base device. At least some of this information returned from the web page interacts with (e.g., updates) a GUI on the base network compatible device that issued the access request, effectively causing the GUI to display specific details received from the web page.

Proceeding to operation 304a, a screenshot of a GUI on the base network compatible device is received in response to accessing the web page. In other words, operation 304a involves receiving and storing a visual representation of the details that are presented on a GUI of the base device in response to visiting the given web page. Operation 304a may thereby be performed in some approaches by sending one or more instructions (e.g., to a network controller) that result in a screenshot being taken of information that is displayed (e.g., output) on a GUI at the base device as a result of visiting the web page. As noted above, the specific configuration of the base device accessing the web page can have an impact on how and/or whether specific details are presented to a user. For example, the aspect ratios implemented in a window of a GUI running on a user's personal computer may impact what and/or how details are displayed.

In response to receiving the screenshot, method 300 advances from operation 304a to operation 306a. There, operation 306a includes using the screenshot to identify elements in the GUI on the base network compatible device. In other words, operation 306a includes inspecting the screenshot of the GUI on the base network compatible device in response to visiting (e.g., accessing) the web page, and automatically identifying elements that are included in the GUI. Depending on the approach, the “elements” identified in the GUI may include general and/or specific portions of text (e.g., alphanumeric characters which correspond to one or more human and/or machine languages), control components (e.g., logical buttons), images, etc. or any other identifiable details. Identifying these elements effectively creates datapoints (e.g., waypoints) that may be used to quantify the layout (e.g., spacing) of information that is presented in a GUI. These datapoints may be collected and compared to elements collected from other screenshots of other GUIs in response to visiting the same web page. This comparison thereby provides insight as to whether the layouts presented in the GUIs change by a significant amount in response to different network compatible devices visiting a web page, e.g., as will be described in further detail below.

In some approaches, operation 306a involves causing one or more trained visual-based AI models to inspect the screenshot of the GUI and identify any desired elements therein. Each of the visual-based AI models may be trained to identify different types of elements from the screenshot of a GUI. For example, one or more AI models may be trained to apply optical character recognition (OCR) using machine learning. These one or more trained models may thereby be used to scan (e.g., visually inspect) the screenshot and recognize (e.g., determine) whether any text based elements are included therein.

From operation 306a, method 300 advances to operation 308a. There, operation 308a includes marking outer borders of the respective identified elements. In other words, outer borders are created around each of the elements that are identified in operation 306a. In some approaches, the outer boarders may be logically added to the screenshot of the GUI received in operation 304a. For instance, the outer boarders may be implemented as a new layer that is added to the file storing the screenshot.

The outer boarders of an element may thereby separate the element from a remainder of the GUI as depicted in the screenshot. Thus, in addition to marking the outer boarders of the elements, the elements themselves may be further differentiated from a remainder of the GUI. For instance, the elements may be identified using high contrast fill, flags and/or pointers, links, etc. In one approach, a first high contrast color may be added inside the outer borders of each element identified in the screenshot, while a second high contrast color is outside the outer borders. According to a non-limiting example, white fill may be added to the area inside each of the outer borders in the screenshot (and/or a copy thereof), while black fill is added to a remainder of the screenshot positioned outside the outer borders. In another approach, the screenshot of the GUI may be converted into positional data, and the outer borders may be represented as corresponding positional data that is stored in a lookup table. Similarly, positional data identifying the area inside each of the outer borders may be stored in a first portion of the lookup table, while positional data identifying a remainder of the screenshot positioned outside the outer borders may be stored in a second portion of the lookup table.

Method 300 further advances from operation 308a to operation 310a. There, operation 310a includes analyzing the screenshot as well as the elements marked therein to determine identifiable characteristics of the GUI. In other words, operation 310a includes inspecting the outer borders of the elements in the screenshot and determining how the elements are situated (e.g., positioned) with respect to each other in the GUI. In some approaches, operation 310a includes determining (e.g., calculating) a distribution of the identified elements across the screenshot of the GUI. In some approaches, operation 310a includes determining an original total area inside the outer borders of the elements. In still other approaches, operation 310a includes determining original margin sizes between outer edges of the GUI and the outer borders the identified elements. According to one example, the elements and their outer borders may be evaluated using one or more computer vision libraries (e.g. OPENCV).

Referring momentarily to FIG. 3B, exemplary sub-operations of analyzing a screenshot of a GUI and the elements therein to determine identifiable characteristics of the GUI, are illustrated in accordance with one approach. It follows that one or more of these sub-operations may be used to perform operation 310a of FIG. 3A. However, it should be noted that the sub-operations of FIG. 3B are illustrated in accordance with one approach which is in no way intended to be limiting. For example, the screenshot of a GUI may be characterized using any desired metrics and/or information. Moreover, one or more of the sub-operations in FIG. 3B may be used to perform operation 310b of FIG. 3A, e.g., as described in further detail below.

Looking now to FIG. 3B, sub-operation 350 includes determining an original distribution of the identified elements. In other words, sub-operation 350 includes calculating a distribution or “discrete degree” of the elements in the screenshot. This distribution may thereby serve as an index that is used to measure (e.g., quantify) the layout of elements in the GUI in response to the base network compatible device accessing the web page in operation 302a.

In some approaches, the distribution or “discrete degree” of the elements in the screenshot may be determined by locating a center point for each of the elements. In other words, a central point between the outer borders of each identified element may be identified. Moreover, the center points of the elements may collectively be used to locate (e.g., calculate) a collective center of the elements in the screenshot of the GUI. Each of the center points may be given an equal weighting in determining the collective center of the elements. However, other approaches may add weights to the center points to shift the collective center of the elements as desired.

From sub-operation 350, the flowchart proceeds to sub-operation 352. There, sub-operation 352 includes determining an original total area inside the outer borders of the elements. In other words, sub-operation 352 includes calculating the total area of the elements that are identified in the screenshot of the GUI. This total area may be determined by measuring dimensions of the elements themselves, estimating surface area using other markers, etc. This total area may serve as another index that quantifies the total area of the elements as displayed on the first GUI output in response to the base network compatible device accessing the web page.

Additionally, the total area outside the outer borders of the elements may be determined in some approaches. In other words, the total amount of the screenshot that does not depict an identified element may be quantified. The total area of the elements may thereby be compared against (e.g., divided by) the remaining area of the screenshot, e.g., to determine a ratio between the two. This ratio may further be referenced in situations where a GUI is expanded to fill portions of a unique display that may otherwise be unused.

Referring still to FIG. 3B, the flowchart proceeds from sub-operation 352 to sub-operation 354. There, sub-operation 354 includes determining original margin sizes between the outer edges of the GUI and the outer border of adjacent ones of the identified elements. In other words, sub-operation 354 includes determining the distance that separates each edge of the GUI from the outer edge of a closest element. These margins may thereby serve as another index that quantifies the amount of space between outermost elements (elements positioned farthest away from the collective center of the elements in the screenshot of the GUI) and an outer border of the GUI output in response to the base network compatible device accessing the web page. These determined original margin sizes may be stored in memory and compared against margin sizes in other GUIs experienced in response to different network compatible devices accessing the same web page.

Returning now to FIG. 3A, it follows that operations 302a through 310a are performed in response to a first network compatible device having a first configuration accessing a given web page. This provides detailed insight into how information (e.g., elements) received in response to accessing the given web page is displayed in a GUI on the first network compatible device. However, a web page may be accessed by other network compatible devices that may have different configurations than the first device evaluated in operations 302a through 310a. As noted above, elements may shift in size and/or spatially in a GUI depending on a configuration of the device that accesses the web page.

Accordingly, the operations in method 300 may be repeated in order for any desired network compatible device(s) having different configurations to access a same web page. In other words, a currently implemented viewport may be switched such that a different network compatible device is able to access the web page, e.g., as would be appreciated by one skilled in the art after reading the present description. This desirably allows for approaches herein to determine how the configuration of a device that accesses a web page impacts how elements are displayed on a GUI of the device. Moreover, adjustments may be made to ensure that information (e.g., elements) are displayed on a GUI in a consistent manner regardless of the type of network compatible device that actually accesses the web page.

For instance, operation 302b includes causing a target network compatible device to access the same web page. In other words, operation 302b includes sending one or more instructions that result in a target device (different than the base device contacted in operation 302a) sending an access request to the predetermined web page. As noted above, the access request may thereby be satisfied, allowing for information to be returned from the web page to the target device. At least some of this information returned from the web page interacts with (e.g., updates) a GUI on the second base network compatible device that issued the access request, effectively causing the GUI to display specific details received from the web page.

While the same information may be returned to the target device in response to accessing the web page, the configuration of the target device may impact how that information is presented to a user. For instance, the target device may implement a different display size, different aspect ratios, different logical and/or physical components, etc., that impact how information (e.g., elements) received from the web page are presented in a GUI on the target device. Thus, 304b includes receiving a screenshot of a second GUI on the second base network compatible device in response to accessing the same web page. In other words, operation 304b involves receiving and storing a visual representation of the elements (e.g., details) that are presented (e.g., output) on a GUI of the target device in response to visiting the given web page. Operation 304b may thereby be performed in some approaches by sending one or more instructions (e.g., to a network controller) that result in a screenshot being taken of information that is displayed on a GUI at the target device as a result of visiting the web page.

In response to receiving the screenshot, method 300 advances from operation 304b to operation 306b. There, operation 306b includes using the screenshot to identify elements in the second GUI on the second base network compatible device. In other words, operation 306b includes inspecting the screenshot of the second GUI on the second base network compatible device in response to visiting (e.g., accessing) the web page, and automatically identifying elements that are included in the second GUI. Accordingly, any of the approaches described above with respect to performing operation 306a may be used to perform operation 306b.

As noted above, the “elements” identified in the second GUI may include general and/or specific portions of text (e.g., alphanumeric characters which correspond to one or more human and/or machine languages), control components (e.g., logical buttons), images, etc. or any other identifiable details. Identifying these elements effectively creates datapoints (e.g., waypoints) that may be used to quantify the layout of information that is presented in the second GUI. These datapoints may be collected and compared to elements collected from other screenshots of other GUIs in response to visiting the same web page. This comparison thereby provides insight as to whether the layouts presented in the GUIs change by a significant amount in response to different network compatible devices visiting a web page, e.g., as will soon become apparent.

From operation 306b, method 300 is shown as advancing to operation 308b. There, operation 308b includes marking outer borders for each of the identified elements. In other words, outer borders are created around each of the elements that are identified in the screenshot of the second GUI in operation 306b. In some approaches, the outer boarders may be logically added to the screenshot of the GUI received in operation 304b. For instance, the outer boarders may be implemented as a new layer that is added to the file storing the screenshot. In other approaches, the outer boarders may be physically added to the screenshot of the GUI received in operation 304b. The outer boarders of an element separate the element from a remainder of the second GUI as depicted in the screenshot. Thus, in addition to marking the outer boarders of the elements, the elements themselves may be further differentiated from a remainder of the second GUI. For instance, the elements may be identified using high contrast fill, flags and/or pointers, links, etc. In one approach, a first high contrast color may be added inside the outer borders of each element identified in the screenshot, while a second high contrast color is outside the outer borders.

Method 300 further advances from operation 308b to operation 310b. There, operation 310b includes analyzing the screenshot as well as the elements marked therein to determine identifiable characteristics of the second GUI. In other words, operation 310b includes inspecting the outer borders of the elements in the screenshot and determining how the elements are situated (e.g., positioned) with respect to each other in the second GUI. In some approaches, operation 310b may include performing one or more of the sub-operations in FIG. 3B. For instance, operation 310b may include determining (e.g., calculating) an updated distribution of the identified elements across the screenshot of the GUI. In some approaches, operation 310b includes determining an updated total area inside the outer borders of the elements. In still other approaches, operation 310b includes determining updated margin sizes between outer edges of the GUI and the outer borders the identified elements.

With continued reference to FIG. 3A, method 300 advances from operations 310a and 310b to operation 312. There, operation 312 includes determining whether the characteristics of the first GUI are sufficiently similar to the characteristics of the second GUI. In other words, operation 312 includes comparing the layouts of elements in the different screenshots to determine whether the GUIs present the elements in a sufficiently similar manner. This may be determined at least in part by computing the variance between characteristics of the GUI screenshots. In other words, a statistical measure that quantifies the amount of variability or dispersion in a dataset may be determined for desired characteristics of the GUI screenshots.

For instance, the variance between the distribution of elements between two GUI screenshots may be determined using Equation 1 below. Similarly, the variance (e.g., difference) between the original area of the elements and the updated area of the elements may be determined using Equation 1 below. Moreover, the variance (e.g., difference) between the original margin sizes and the updated margin sizes of the respective GUIs may be determined using Equation 1 below.

$$Variance = ( 1 / n ) * Σ ( {( {x}_{i} - µ )}^{2} ) \qquad Equation 1$$

Here, “n” represents the total number of datapoints in the dataset being evaluated, while “μ” represents the mean value of all datapoints. Moreover, “xᵢ” stands for each respective datapoint. As shown, the squared differences between each datapoint and the mean are combined and divided by the total number of datapoints to obtain an average. The variance thereby provides a measure of the average squared deviation from the mean, reflecting the extent of dispersion or spread in a given dataset. Accordingly, calculating variance of distances in a dataset includes reflecting the discrete degree of target objects in a given web page.

Looking momentarily to FIG. 3C, exemplary sub-operations of comparing the characteristics of a first GUI with the characteristics of a second GUI, are illustrated in accordance with one approach. It follows that one or more of these sub-operations may be used to perform operation 312 of FIG. 3A. However, it should be noted that the sub-operations of FIG. 3C are illustrated in accordance with one approach which is in no way intended to be limiting. For example, GUIs may be compared using any desired characteristics.

As shown, sub-operation 370 of FIG. 3C includes determining whether a difference between an original distribution and an updated distribution is outside a first predetermined range. In other words, sub-operation 370 includes comparing an original distribution of elements in a first GUI with an updated distribution of elements in a second GUI, and determining whether a number of differences that exist between the distributions is undesirably high. Depending on the approach, the first predetermined range may be set by a user, be automatically generated by one or more trained AI based models, based at least in part on industry standards, etc.

The flowchart is shown as proceeding directly from sub-operation 370 back to sub-operation 314 of FIG. 3A in response to determining that a number of differences between the original distribution and the updated distribution is outside the first predetermined range. In other words, the flowchart jumps directly back to operation 314 in response to determining that layouts of the two GUIs being compared are undesirably different. There, operation 314 includes outputting an alert indicating the web page has a layout issue, e.g., as will be described in further detail below.

However, the flowchart of FIG. 3C advances from sub-operation 370 to sub-operation 372 in response to determining that a number of differences between the original distribution and the updated distribution is not outside the first predetermined range. In other words, the flowchart proceeds to sub-operation 372 in response to determining the distribution of elements in the different GUIs are sufficiently similar. There, sub-operation 372 includes comparing the original area inside the outer borders of the elements identified in the screenshot of the first GUI with the updated area inside the outer borders of the updated elements in the screenshot of the second GUI. Specifically, sub-operation 372 includes determining whether a difference between the original area and the updated area is outside a second predetermined range. In other words, sub-operation 372 includes determining whether the relative size of each element changes by an undesirable amount between the screenshots of the different GUIs. Moreover, the second predetermined range may be set by a user, be automatically generated by one or more trained AI based models, based at least in part on industry standards, etc., e.g., depending on the approach.

The flowchart is shown as proceeding directly from sub-operation 372 back to sub-operation 314 of FIG. 3A in response to determining that a difference between the original area and the updated area is outside the second predetermined range. In other words, the flowchart jumps directly back to operation 314 in response to determining that the two GUIs present (at least some of) the same elements in undesirably different ways. However, the flowchart of FIG. 3C advances from sub-operation 372 to sub-operation 374 in response to determining that a difference between the original area and the updated area is not outside the second predetermined range. There, sub-operation 374 includes comparing the original margin sizes with the updated margin sizes of the respective GUIs. Specifically, sub-operation 374 includes determining whether a difference between the size(s) of the original margins (measured between outer edges of the first GUI and the outer border of adjacent ones of the identified elements), and the size(s) of the updated margins (measured between outer edges of the second GUI and the outer border of adjacent ones of the updated elements) are outside a third predetermined range. In other words, sub-operation 374 includes determining whether the relative size of the margins in GUIs change by an undesirable amount between the screenshots. Moreover, the third predetermined range may be set by a user, be automatically generated by one or more trained AI based models, based at least in part on industry standards, etc., e.g., depending on the approach. Moreover, the first, second, and/or third predetermined ranges may be different, similar to each other, the same, etc., depending on the approach.

The flowchart is shown as proceeding directly from sub-operation 374 back to sub-operation 314 of FIG. 3A in response to determining that the difference between the sizes of the original margins and the updated margins are outside the third predetermined range. However, the flowchart proceeds from sub-operation 374 back to sub-operation 316 of FIG. 3A in response to determining that the difference between the sizes of the original margins and the updated margins are not outside the third predetermined range. In other words, the flowchart of FIG. 3C is shown as advancing to operation 316 in response to determining a difference between the original distribution and the updated distribution is inside a first predetermined range; as well as in response to determining a difference between the original area and the updated area is inside a second predetermined range; and in response to determining a difference between the original margin sizes and the updated margin sizes is inside a third predetermined range.

It follows that the sub-operations of FIG. 3C are able to verify GUI layouts are consistent across a variety of different devices without manually testing each of them. The automated approaches described herein may thereby be able to efficiently identify layout issues experienced as a result of visiting responsive web pages and/or other types of adaptive applications. Moreover, approaches herein ensure these issues are resolved such that any network compatible device is able to properly access information on the web pages.

Returning again now to FIG. 3A, method 300 advances from operation 312 to operation 314 in response to determining that the characteristics of the first GUI are not sufficiently similar to the characteristics of the second GUI. In other words, method 300 advances from operation 312 to operation 314 in response to determining elements are presented differently in the first GUI in response to a first device accessing a web page than how elements are presented in a second GUI in response to a second device accessing the same web page. As alluded to above, operation 314 includes outputting an alert indicating the web page has a layout issue. Depending on the approach, the alert may be sent (e.g., transmitted) to an administrator (e.g., architect) of the web page, a manufacturer of the network compatible device used to access the web page, a user attempting to access the web page, etc. The alert may thereby desirably cause the web page and/or the GUIs of network compatible devices used to access the web page are modified such that consistency across the GUIs of the devices are consistent.

Alternatively, method 300 is shown as advancing from operation 312 to operation 316 in response to determining that the GUI screenshots being compared are sufficiently similar. According to some approaches, method 300 advances to operation 316 in response to determining that a difference between the original distribution and the updated distribution is inside a first predetermined range; and in response to determining a difference between the original area and the updated area is inside a second predetermined range; and in response to determining a difference between the original margin sizes and the updated margin sizes is inside a third predetermined range. There, operation 316 includes outputting a conclusion indicating the web page does not have layout issues.

Method 300 is further depicted as advancing from operations 314 and 316 to operation 318. There, operation 318 includes generating a test report that summarizes the results of comparing the screenshots of the GUIs. The test report may thereby include the calculated differences between the original elements in the screenshot of the first GUI and the updated elements in the screenshot of the second GUI. These differences may also be stored in memory, sent to a target location (e.g., a user, administrator, etc.) for review, etc.

The operations in method 300 are thereby desirably able to automatically test the layout of a GUI in a number of different configurations. For instance, one or more of the operations in method 300 may be performed to determine whether the layout of a GUI changes by a sufficient amount on different network compatible devices in response to accessing a web page. As noted above, different network compatible devices have different configurations (e.g., display sizes, aspect ratios, programming languages, etc.) which impacts if and/or how a GUI is able to present certain details to a user. Operations in method 300 are thereby able to improve the accessibility of information across network compatible devices by automatically testing how the layout of interactive sources of information are impacted in a variety of different configurations.

This is particularly true with respect to responsive web pages having flexible characteristics that are generally designed to adapt to different network compatible devices. Again, while responsive web pages are preferably configured such that they are able to adapt to a number of different access scenarios, approaches herein are able to achieve this without significantly increasing latency. For example, rather than manually performing tedious and repetitive layout verifications for each type of network compatible device, viewport size, resolution, etc. that may potentially be used to access a responsive web page, approaches herein are desirably able to achieve web development that uses flexible grids, responsive images, and media queries to achieve compatibility with a variety of network compatible components.

Each component of a responsive web page may thereby undergo change(s) to be included inside the outer boundaries of a screen displaying a GUI on a network compatible device. For example, the components may shrink to fit into smaller device screens or, on the contrary, stretch to occupy devices having larger screen surface areas. This may be accomplished in some approaches by resizing viewports, modifying displayed resolutions, shifting between layout configurations, etc. Moreover, this scaling is preferably done automatically to match the respective network compatible device.

Approaches herein are thereby able to reduce research and development costs by generating responsive web pages that achieve consistent layouts on different GUIs. For example, some approaches herein utilize automated checking tools that are able to significantly reduce verifying costs, decrease human intervention, increase efficiency, improve customer satisfaction, etc. Automated testing that is capable of detecting layout problems in responsive web page(s) with improved software development efficiency is thereby achieved herein.

In some approaches, the operations of method 300 may be performed by an AI model that is trained using predetermined training set(s) of data. For example, in some approaches, various of the operations noted above may be deployed in a trained state of a trained AI model. Training of the AI model, in some approaches, may be performed by applying a predetermined training data set to learn how to compare different details present in a GUI and how those details are impacted based on the physical device the GUI is loaded in. Initial training may include reward feedback that may, in some approaches, be implemented using a subject matter expert (SME) that generally understands GUI layouts and how they are impacted in response to different types of network compatible devices accessing a given web page (e.g., a responsive web page). However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 300 may be performed. In some further approaches, the AI model may be a deep learning AI model that may improve performance of computer devices in an infrastructure associated with developing and/or managing web pages, because the deep learning AI model may not need an SME and/or iteratively applied training with reward feedback in order to accurately perform operations described herein. Instead, the deep learning AI model is configured to itself make determinations described in operations herein.

Weight values may, in some approaches, be used by the AI reasoning model to collect and analyze information and/or feedback potentially received in response to evaluating the layout(s) of one or more GUIs. Such an AI model ensures that re-training occurs, during which the accuracy of the values generated by the AI model(s), and used to quantify the layout of a given GUI, is evaluated. In situations where the accuracy of the layouts decline, the data used to train the AI model(s) may be shifted (e.g., weighted) such that the AI model(s) are able to more effectively evaluate the GUI screenshots as a result of the re-training, where the scale of such analysis and determinations would not otherwise be feasible for a human to perform. This is because humans are not able to efficiently perform complex re-training resulting from dynamic evaluation of complex configurations (e.g., layouts) of elements in a GUI, and would otherwise incorporate processing delays and errors in the process of attempting to do so. Accordingly, management of operations described herein is not able to be achieved by human manual actions.

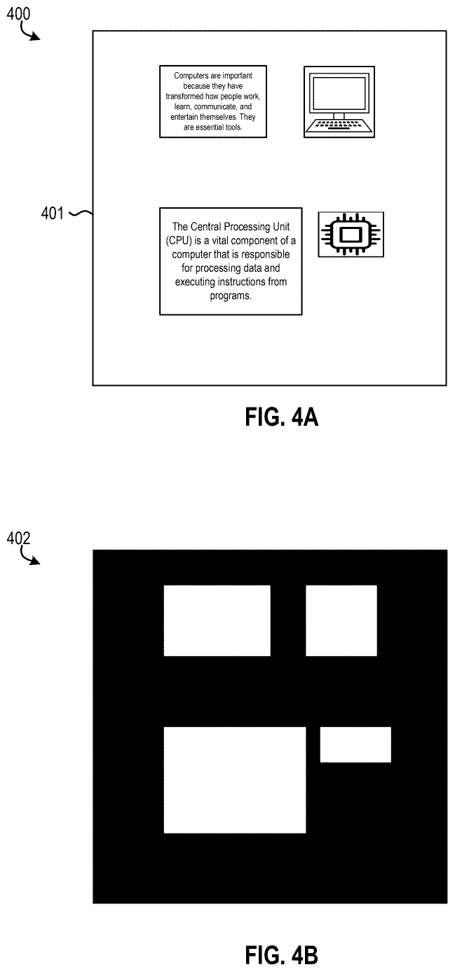

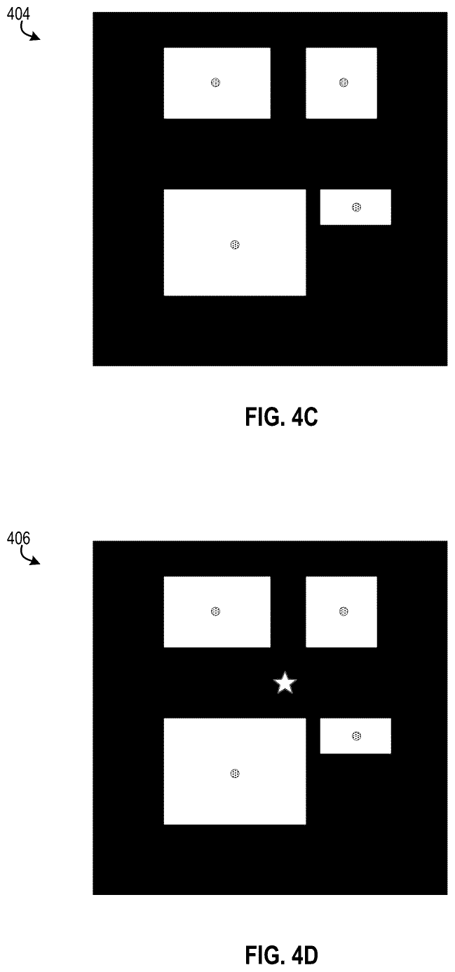

Referring now to FIGS. 4A-4D, the steps of a progression are illustrated in accordance with an in-use example which is in no way intended to be limiting. Looking first to FIG. 4A, a first step 400 of the progression is depicted. There, FIG. 4A includes obtaining a screenshot 401 of a GUI on a network compatible device in response to accessing a web page. In some approaches, the screenshot may be received from a screen capture module (e.g., see Screen Capture Module of FIG. 2B above) that is configured to store visual representations of GUIs that are presented on a given device.

In response to receiving the screenshot 401, one or more trained AI based models may be used to evaluate the screenshot and identify any elements that are included therein. In some approaches, an AI based OCR model may be used to evaluate the received screenshot and identify any text based elements therein. In other approaches, AI based models that have been trained to identify visual items (e.g., pictures, icons, graphical representations, etc.) may be used to evaluate the screenshot and identify additional elements therein. Moreover, in response to identifying the elements in the screenshot, outer borders which surround each of the respective elements are added to the snapshot, e.g., as shown.

Advancing to FIG. 4B, there high contrast coloring has been added to the snapshot in step 402. In the present example, white coloring (a first high contrast color) has been added inside the outer borders of each element identified in step 400, while black coloring (a second high contrast color) has been added outside the outer borders. It follows that in addition to marking the outer boarders of the elements, the elements themselves may be further differentiated from a remainder of the GUI to ensure each element is evaluated.

Proceeding to step 404 in FIG. 4C, there a center point for each of the elements is identified. In other words, a central point between the outer borders of each identified element may be identified. Moreover, the center points of the elements may be used to locate (e.g., calculate) a collective center of the elements in the screenshot of the GUI. For example, step 406 in FIG. 4D illustrates the collective center of the elements added to the screenshot of the GUI. As noted above, in some approaches each of the center points may be given an equal weighting in determining a true center of the elements. However, other approaches may add weights to the center points to shift the collective center of the elements as desired.

The center points of the elements and the collective center point determined in steps 404, 406 respectively, may be used to determine a distribution or “discrete degree” of the elements in the screenshot. For instance, distances between the collective center of the GUI and the respective center points of the elements may be determined. As noted above, these distances (e.g., distribution) may be used as a first index that is used to measure (e.g., quantify) the layout of elements in the GUI in response to a network compatible device accessing a web page. In some approaches, the center points of the elements may be used in combination with known areas inside the respective outer borders to determine the margins between outermost ones of the elements and an edge of the GUI screenshot, e.g., as described herein.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A method comprising:
receiving a screenshot of a graphical user interface (GUI) on a base device output in response to the base device accessing a web page;
using the screenshot to identify elements in the GUI;
marking outer borders of the respective identified elements;
determining an original distribution of the identified elements;
determining an original area inside the outer borders; and
determining original margin sizes between edges of the GUI and the outer border of adjacent ones of the identified elements.

2. The method of claim 1, further comprising:
receiving a second screenshot of a second GUI on a target device output in response to the target device accessing the web page;
using the second screenshot to identify updated elements in the second GUI;
marking outer borders of the respective updated elements;
determining an updated distribution of the updated elements;
determining an updated area inside the outer borders of the updated elements; and
determining updated margin sizes between edges of the second GUI and the outer border of adjacent ones of the updated elements.

3. The method of claim 2, further comprising:
comparing the original distribution with the updated distribution; and
in response to a difference between the original distribution and the updated distribution being outside a predetermined range, outputting an alert indicating the web page has a layout issue.

4. The method of claim 2, further comprising:
comparing the original area with the updated area; and
in response to a difference between the original area and the updated area being outside a predetermined range, outputting an alert indicating the web page has a layout issue.

5. The method of claim 2, further comprising:
comparing the original margin sizes with the updated margin sizes; and
in response to a difference between the original margin sizes and the updated margin sizes being outside a predetermined range, outputting an alert indicating the web page has a layout issue.

6. The method of claim 2, further comprising:
outputting that the web page has no layout issues in response to:
determining a difference between the original distribution and the updated distribution is inside a first predetermined range,
determining a difference between the original area and the updated area is inside a second predetermined range, and
determining a difference between the original margin sizes and the updated margin sizes is inside a third predetermined range.

7. The method of claim 1, further comprising:
in response to identifying the elements on the GUI:
marking the outer borders of the respective identified elements;
adding a first high contrast color inside the outer borders; and
adding a second high contrast color outside the outer borders.

8. The method of claim 1, wherein the elements are selected from the group consisting of: text, control components, and images.

9. The method of claim 1, wherein identifying elements in the GUI includes causing a trained visual-based AI model to scan the GUI and recognize the elements therein.

10. A computer program product comprising:
one or more computer-readable storage media; and
program instructions stored on the one or more storage media to perform operations comprising:
receiving a screenshot of a graphical user interface (GUI) on a base device output in response to the base device accessing a web page;
using the screenshot to identify elements in the GUI ;
marking outer borders of the respective identified elements;
determining an original distribution of the identified elements;
determining an original area inside the outer borders; and
determining original margin sizes between edges of the GUI and the outer border of adjacent ones of the identified elements.

11. The computer program product of claim 10, wherein the operations further comprise:
receiving a second screenshot of a second GUI on a target device output in response to the target device accessing the web page;
using the second screenshot to identify updated elements in the second GUI;
marking outer borders of the respective updated elements;
determining an updated distribution of the updated elements;
determining an updated area inside the outer borders of the updated elements; and
determining updated margin sizes between edges of the second GUI and the outer border of adjacent ones of the updated elements.

12. The computer program product of claim 11, wherein the operations further comprise:
comparing the original distribution with the updated distribution; and
in response to a difference between the original distribution and the updated distribution being outside a predetermined range, outputting an alert indicating the web page has a layout issue.

13. The computer program product of claim 11, wherein the operations further comprise:
comparing the original area with the updated area; and
in response to a difference between the original area and the updated area being outside a predetermined range, outputting an alert indicating the web page has a layout issue.

14. The computer program product of claim 11, wherein the operations further comprise:
comparing the original margin sizes with the updated margin sizes; and
in response to a difference between the original margin sizes and the updated margin sizes being outside a predetermined range, outputting an alert indicating the web page has a layout issue.

15. The computer program product of claim 11, wherein the operations further comprise:
outputting that the web page has no layout issues in response to:
determining a difference between the original distribution and the updated distribution is inside a first predetermined range,
determining a difference between the original area and the updated area is inside a second predetermined range, and
determining a difference between the original margin sizes and the updated margin sizes is inside a third predetermined range.

16. The computer program product of claim 10, wherein the operations further comprise:
in response to identifying the elements on the GUI:
marking the outer borders of the respective identified elements;
adding a first high contrast color inside the outer borders; and
adding a second high contrast color outside the outer borders.

17. The computer program product of claim 10, wherein the elements are selected from the group consisting of: text, control components, and images.

18. The computer program product of claim 10, wherein identifying elements in the GUI includes causing a trained visual-based AI model to scan the GUI and recognize the elements therein.

19. A computer system comprising:
a processor set;
one or more computer-readable storage media; and
program instructions stored on the one or more storage media to cause the processor set to perform operations comprising:
receiving a screenshot of a graphical user interface (GUI) on a base device output in response to the base device accessing a web page;
using the screenshot to identify elements in the GUI;
marking outer borders of the respective identified elements;
determining an original distribution of the identified elements;
determining an original area inside the outer borders; and
determining original margin sizes between edges of the GUI and the outer border of adjacent ones of the identified elements.

20. The computer system of claim 19, wherein the operations further comprise:
receiving a second screenshot of a second GUI on a target device output in response to the target device accessing the web page;
using the second screenshot to identify updated elements in the second GUI;
marking outer borders of the respective updated elements;
determining an updated distribution of the updated elements;
determining an updated area inside the outer borders of the updated elements;
determining updated margin sizes between edges of the second GUI and the outer border of adjacent ones of the updated elements; and
outputting that the web page has no layout issues in response to:
determining a difference between the original distribution and the updated distribution is inside a first predetermined range,
determining a difference between the original area and the updated area is inside a second predetermined range, and
determining a difference between the original margin sizes and the updated margin sizes is inside a third predetermined range.
